(19) United States
(12) Patent Application Publication
(10) Pub. No.: US 2022/0126875 A1
(43) Pub. Date: Apr. 28, 2022

(54) CONTROL OF AN AUTONOMOUS VEHICLE BASED ON BEHAVIOR OF SURROUNDING AGENTS AND LIMITED OBSERVATIONS OF ENVIRONMENT

(71) Applicant: TUSIMPLE, INC., San Diego, CA (US)

(72) Inventor: Riad I. HAMMOUD, San Diego, CA (US)

(21) Appl. No.: 17/495,063

(22) Filed: Oct. 6, 2021

Related U.S. Application Data
(60) Provisional application No. 63/105,487, filed on Oct. 26, 2020.

(51) Int. Cl. B60W 60/00

(52) U.S. Cl. CPC B60W 60/0027; B60W 2554/4044; B60W 2554/4046; B60W 2554/406; B60W 2555/20; B60W 2554/4041

(57) ABSTRACT

An autonomous vehicle includes an apparatus for determining a confidence level of perception data gathered from vehicle sensor subsystems, as well as determining a confidence level of a regional map. The system is also configured to determine an action of agents of interest in front of the autonomous vehicle. A method of controlling the autonomous vehicle utilizing the system includes altering the trajectory of the autonomous vehicle in response to the confidence level determined for the perception data and regional map.

### CROSS-REFERENCE TO RELATED APPLICATION

This application claims the benefit of U.S. Provisional Patent Application No. 63/105,487, filed Oct. 26, 2020, the contents of which are incorporated by reference herein in its entirety.

### TECHNICAL FIELD

The present disclosure relates generally to autonomous vehicles. More particularly, the present disclosure is related to utilizing behaviors of vehicles, pedestrians, or objects surrounding an autonomous vehicle (AV) to increase the confidence in identifying agents of interest and potential hazards in the environment to operate the AV appropriately.

### BACKGROUND

Self-driving or autonomous vehicles can be autonomously controlled to navigate along a path to a destination. Autonomous driving generally requires sensors and processing systems that perceive the environment surrounding an autonomous vehicle and make decisions based on that perception that ensure safe and reliable operation of the autonomous vehicle. For example, the sensors of the autonomous vehicle can include video cameras and/or light detection and ranging (LiDAR) sensors. LiDARs use light pulses to measure distances to various objects surrounding the autonomous vehicle.

### SUMMARY

The ability to have confidence in perception data and accurately act upon that data is important for the operation of an autonomous vehicle to ensure the safety of persons and property surrounding the autonomous vehicle. Systems and methods described herein allow, among other features and benefits, an autonomous vehicle to accurately determine the presence (or, alternatively, the absence) of a hazard or a change in road conditions and to adjust operation of the autonomous vehicle accordingly for safe and lawful operation.

An example aspect of the disclosed embodiments relates to a method that includes determining, based on sensor data received from one or more sensors of an autonomous vehicle, an initial confidence level based on an expected quality of the sensor data. The method further includes determining, based on object attributes of one or more objects in an area proximate to the autonomous vehicle, an adjusted confidence level, each object attribute comprising a state, an action, and/or a behavior of each of the one or more objects in the area proximate to the autonomous vehicle. The method also includes altering, based on the adjusted confidence level, a planned path of the autonomous vehicle.

Another example aspect of the disclosed embodiments relates to an apparatus that includes one or more processors and at least one memory including computer program instructions which, when executed by the one or more processors, cause operations comprising determining, based on sensor data received from one or more sensors of an autonomous vehicle, an initial confidence level based on an expected quality of the sensor data. The operations also comprise determining, based on object attributes of one or more objects in an area proximate to the autonomous vehicle, an adjusted confidence level, each object attribute comprising a state, an action, and/or a behavior of each of the one or more objects in the area proximate to the autonomous vehicle. The operations also comprise altering, based on the adjusted confidence level, a planned path of the autonomous vehicle.

Yet another example aspect of the disclosed embodiments relates to a non-transitory computer readable medium including instructions which, when executed by at least one processor, cause operations comprising determining, based on sensor data received from one or more sensors of an autonomous vehicle, an initial confidence level based on an expected quality of the sensor data. The operations further comprise determining, based on object attributes of one or more objects in an area proximate to the autonomous vehicle, an adjusted confidence level, each object attribute comprising a state, an action, and/or a behavior of each of the one or more objects in the area proximate to the autonomous vehicle. The operations also comprise altering, based on the adjusted confidence level, a planned path of the autonomous vehicle.

The above and other aspects and features of the present disclosure are described in greater detail in the drawings, the description and the claims.

### BRIEF DESCRIPTION OF THE DRAWINGS

FIG. 1 illustrates a schematic diagram of a system including an autonomous vehicle according to the present disclosure.

FIG. 2 is a schematic showing data flows in a system including a meta-perception computing module according to the present disclosure.

FIG. 3 shows a flow diagram of an example embodiment of a method according to the present disclosure.

FIG. 4 shows a flow diagram of an example embodiment of another method according to the present disclosure.

### DETAILED DESCRIPTION

Autonomous driving systems (also referred to as autonomous driving vehicles, autonomous vehicles, or self-driving vehicles) should safely and reliably accommodate all types of traffic situations that they can encounter on various roads and in different driving conditions and environments.

One aim of autonomous vehicle technologies is to provide vehicles that can safely navigate towards a destination with limited or no driver assistance. In some cases, an autonomous vehicle may encounter situations or environments where higher uncertainty about the identification of a potential hazard, such as an object, adjacent vehicle, or road condition may exist. Currently in such cases, assistance from a driver or human review of perception data is usually needed to guide the autonomous vehicle to safely navigate past the complicated situation. Previous systems do not enable autonomous vehicles to discern the actual level of hazard with high confidence in some situations where sensors of an autonomous vehicle are occluded or behavior of agents (e.g., vehicles, pedestrians) surrounding the autonomous vehicle is erratic.

An autonomous vehicle can use its sensors including, for example, accelerometers, gyroscopes, inertial measurement units (IMUs; an IMU can typically include one or more accelerometers and/or gyroscopes), LiDAR sensors, video cameras, radar (radio detection and ranging) sensors, wind speed sensors, and/or temperature sensors to determine and/or monitor its own state as well as the states and/or behaviors of other vehicles around it. The other vehicles may be autonomous and/or manually operated.

A state of a vehicle can include, e.g., information related to its position (also referred to as location or coordinate(s)) in, e.g., a one-dimensional (1D), two-dimensional (2D) or three-dimensional (3D) coordinate system, its speed (a scalar value) or velocity (a vector) and/or its acceleration (a scalar or a vector). The position, speed, velocity, acceleration of a vehicle (e.g., an autonomous vehicle) can be specified or determined (e.g., measured) relative to a certain point or object in space (or a system of coordinates) such as, e.g., relative to another vehicle. A state of a vehicle can also include, e.g., information related to whether the vehicle displays any visual signs or indicators including, e.g., a turn (left or right) signal or indicator, brake lights, reverse movement lights, parking lights, or emergency lights (also referred to as hazard lights).

A vehicle behavior can include, e.g., characteristics of the vehicle's path (e.g., whether the path of the vehicle goes through multiple traffic lanes), as well as characteristics of the vehicle progression along the path (e.g., how aggressively the vehicle changes lanes; how often the vehicle performs (sharp) accelerations and/or decelerations (braking); etc.).

Based on the states and behaviors of other vehicles determined using data provided by the autonomous vehicle sensors, the autonomous vehicle can decide whether and how it can proceed along a planned path. For example, the autonomous vehicle can determine a maximum speed it can maintain on a current stretch of a road (e.g., within the speed limit set for the road), the kinds of maneuvers it can safely perform and how fast it can perform those maneuvers while traveling within that stretch. Based on its analysis of the sensor data, the autonomous vehicle can also make corrections to the planned path, if necessary.

Vehicles traversing highways and roadways are faced with changes in road conditions and unexpected situations, such as accidents and debris in the roadway, in the course of safe operation of the vehicle. For autonomous vehicles, particularly autonomous tractor trailers determining the veracity of the identification of a hazard on the road is essential for safe operation of the vehicle. That is to say that accurate identification of a hazard with confidence is needed to guide the trajectory of an autonomous vehicle traveling over public highways and roads. Described below are systems and methods for the safe operation of an autonomous vehicle on a roadway, including determination of a confidence level of data indicating a hazard and execution of maneuvers that account for the identified hazard. Among other benefits, technology disclosed in this patent document can improve reliability and safety of the autonomous vehicle's operation.

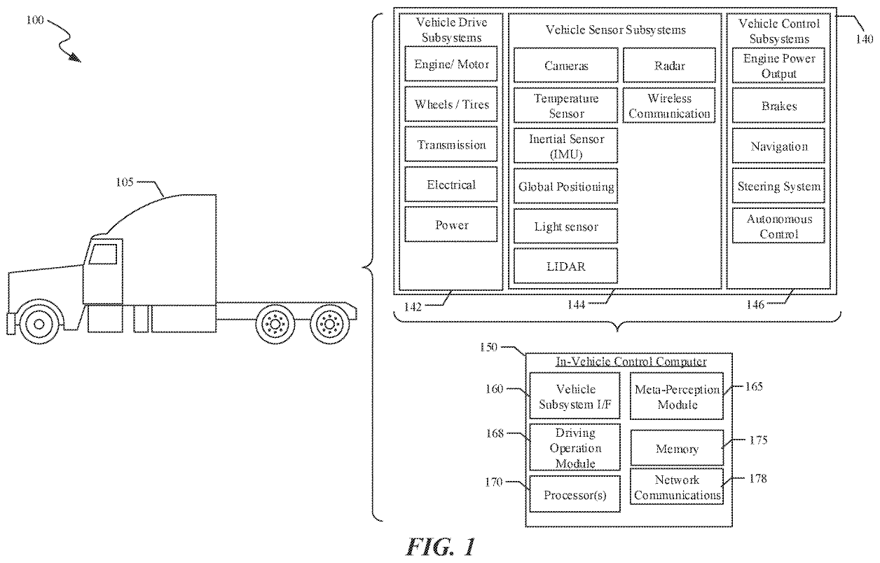

FIG. 1 shows a system 100 that includes a tractor 105 of an autonomous truck. The tractor 105 may include a plurality of vehicle subsystems 140 and an in-vehicle control computer 150. The plurality of vehicle subsystems 140 can include, for example, vehicle drive subsystems 142, vehicle sensor subsystems 144, and vehicle control subsystems 146. An engine or motor, wheels and tires, a transmission, an electrical subsystem, and a power subsystem may be included in the vehicle drive subsystems 142. The engine of the autonomous truck may be an internal combustion engine, a fuel-cell powered electric engine, a battery powered electric engine, a hybrid engine, or another type of engine capable of moving the wheels on which the tractor 105 (also referred to as vehicle 105 or truck 105) moves. The tractor 105 can have multiple motors or actuators to drive its wheels. For example, the vehicle drive subsystems 142 can include two or more electrically driven motors. The transmission of the vehicle 105 may include a continuous variable transmission or a set number of gears that translate power created by the engine of the vehicle 105 into a force that drives the wheels of the vehicle 105. The vehicle drive subsystems 142 may include an electrical system that monitors and controls the distribution of electrical current to components within the vehicle drive subsystems 142 (and/or within the vehicle subsystems 140), including pumps, fans, and actuators. The power subsystem of the vehicle drive subsystems 142 may include components that regulate the power source of the vehicle 105.

Vehicle sensor subsystems 144 can include sensors for general operation of the autonomous truck 105. The sensors for general operation of the autonomous vehicle may include, for example, one or more cameras, a temperature sensor, an inertial sensor, a global positioning system (GPS), a light sensor, a LiDAR system, a radar system, and/or a wireless communications system.

The vehicle control subsystems 146 may be configured to control operation of the autonomous vehicle, or truck, 105 as a whole and operation of its various components. Accordingly, the vehicle control subsystems 146 may include various elements including, e.g., an engine power output subsystem, a brake unit, a navigation unit, a steering system, and an autonomous control unit. The engine power output subsystem may control the operation of the engine, including, e.g., the torque produced, or horsepower provided, as well as provide control of the gear selection of the transmission. The brake unit can include any combination of mechanisms configured to decelerate the autonomous vehicle 105. The brake unit can use friction to slow the wheels in a standard manner. The brake unit may include an anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically based on, e.g., traffic or road conditions, while the autonomous vehicle 105 is in operation. In some embodiments, the navigation unit may be configured to incorporate data from a GPS device and one or more predetermined maps so as to determine the driving path for the autonomous vehicle 105. The steering system may represent any combination of mechanisms that may be operable to adjust the heading of the autonomous vehicle 105 in an autonomous mode or in a driver-controlled mode.

The autonomous control unit may include a control system configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some embodiments, the autonomous control unit may be configured to incorporate data from the GPS device, the radar, the LiDAR, the cameras, and/or other vehicle sensors and subsystems to determine the driving path or trajectory for the autonomous vehicle 105.

An in-vehicle control computer 150, which also may be referred to as a vehicle control unit or VCU, can include, for example, any of: a vehicle subsystem interface 160, a driving operation module 168, one or more processors 170, a meta-perception module 165, a memory 175, or a network communications subsystem 178. This in-vehicle control computer 150 controls many, if not all, of the operations of the autonomous truck 105 in response to information from the various vehicle subsystems 140.

The one or more processors 170 can be configured to execute operations associated with the meta-perception module 165 which, for example, can allow the meta-perception module 165 (or the in-vehicle control computer 150) to determine a confidence level (or a level of confidence, also referred to as a confidence value) for perception data indicating, e.g., a hazard, and/or determine a confidence level for a regional map, and/or analyze behaviors of agents of interest (also referred to as targets) surrounding the autonomous vehicle 105.

A meta-perception module (e.g., the meta-perception module 165) may be a device or a system which can be configured to combine several types of information, data, and/or knowledge to infer information and/or data related to, e.g., a situation or a scenario such as, e.g., a situation which involves an autonomous vehicle that carries the meta-perception module and one or more vehicles and/or objects in the environment external with respect to the autonomous vehicle. The meta-perception module can also be configured to generate a confidence level (or an estimate of a confidence level) for, e.g., a hazard detected by, e.g., sensors of the autonomous vehicle (e.g., sensors of the vehicle sensor subsystems 144 of the vehicle 105) using the several types of information, data, and/or knowledge. The information and/or data can be obtained by the meta-perception module from, e.g., sensors of the autonomous vehicle (e.g., sensors of the vehicle sensor subsystems 144 of the vehicle 105). The meta-perception module can also include or be communicatively connected to a data storage device or a data source which can provide data, information or knowledge that it stores to the meta-perception module in response to, e.g., a request made by the meta-perception module. The information, data, or knowledge can be obtained by the meta-perception module from a source which is external with respect to the vehicle which carries or includes the meta-perception module.

According to some example embodiments, perception data may be data captured by one or more sensors of an autonomous vehicle such as, for example, the sensors of the vehicle sensor subsystems 144 of the vehicle 105. In some example embodiments, perception data may be data obtained via processing or transforming the data captured by the one or more sensors of the autonomous vehicle.

According to some example embodiments, a regional map may include a topographic map of an area. In some example embodiments, a regional map may include data which correspond to a representation of objects in the environment around an autonomous vehicle in a computer-readable form. According to some example embodiments, a regional map may include coordinates (e.g., GPS coordinates) of objects, structures (e.g., buildings, bridges, road signs, etc.), etc. in an area proximate to the autonomous vehicle. A regional map may be obtained using an object segmentation or an image segmentation process performed, e.g., on an image captured, for example, by a video camera or by a LiDAR sensor of the autonomous vehicle. In some example embodiments, a regional map may be generated via assigning a particular class (and/or a GPS coordinate) to each element (e.g., a pixel) of a set of data (also referred to as a dataset which can be, e.g., an image obtained from a video camera or a data frame captured by a LiDAR).

A confidence level for, e.g., perception data (e.g., perception data of a regional map), can be expressed, according to some example embodiments, as a percentage (e.g., a value between 0% and 100%) or as a fraction or a probability (e.g., a value between 0 and 1). A confidence level determined for or assigned to perception data (or a regional map) may correspond to a measure of quality of the perception data (or the regional map). According to some example embodiments, a confidence level assigned to current perception data may correspond to a likelihood or a probability that the perception data or a characteristic or parameter of the perception data or a characteristic or parameter or information obtained using the perception data can change substantially compared to the current perception data when the autonomous vehicle acquires the perception data again at, e.g., a later point in time. Changes in the perception data may be related to movements of the autonomous vehicle and/or to changes in the environment around the autonomous vehicle. A confidence level determined for perception data (or a regional map), which are obtained using, e.g., a procedure or a set of measurements, may also correspond to a likelihood or a probability that repeating the procedure or the measurements would generate perception data which possess a characteristics or a property (e.g., an average value) which lies within a certain confidence interval around a certain value of the characteristics or the property. The characteristics or properties can be, for example, statistical characteristics or properties. The confidence level determined for perception data (or a regional map) which is also referred to as the confidence level of the perception data (or the regional map) may also correspond to a likelihood or a probability that a “true” characteristics or measure of a real-world or physical object for which the perception data were captured lies within a certain interval (e.g., a confidence interval) around the value of the characteristics or measure obtained using the perception data. For example, a confidence level of 95% paired with a confidence interval+/−3% ascribed to a distance of 100 meters to an object obtained using perception data (e.g., data provided by a LiDAR sensor or a camera of an autonomous vehicle) can mean that one can be 95% certain that the interval of distances between (100 m−3%*100 m=97 m) and (100 m+3%*100 m=103 m) contains the true distance to the object.

A collective trajectory of multiple objects (or a group of objects) present in an area around the autonomous vehicle may be a path or a trajectory determined using a path or a trajectory of each individual object in the multiple objects (or the group). In some example embodiments, a collective trajectory of a group of objects may correspond to a trajectory of a center of the group of objects. The center can be computed as a geometric center of the group, for example.

An agent of interest (AOI) or a target may refer to, among other things: another vehicle, a vehicle following the autonomous vehicle 105, a vehicle in a vicinity of the autonomous vehicle 105, a pedestrian, a construction zone, or a vehicle proximate to the autonomous vehicle 105.

Data from the vehicle sensor subsystems 144 may be provided to the meta-perception module 165 so that the course of action for the autonomous vehicle 105 may be appropriately determined. Alternatively, or additionally, the meta-perception module 165 may determine the course of action in conjunction with another operational or control module, such as, e.g., the driving operation module 168.

The memory 175 may include instructions to transmit data to, receive data from, interact with, or control one or more of the vehicle drive subsystems 142, vehicle sensor subsystems 144, or vehicle control subsystems 146. The in-vehicle control computer (VCU) 150 may control the function of the autonomous vehicle 105 based on inputs received from various vehicle subsystems (e.g., the vehicle drive subsystems 142, the vehicle sensor subsystems 144, and the vehicle control subsystems 146). The VCU 150 may, for example, send information to the vehicle control subsystems 146 to direct or control functions including, e.g., the trajectory, velocity, and signaling behaviors of the autonomous vehicle 105. The vehicle control subsystems 146 may receive a course of action to be taken from one or more modules of the VCU 150 and may, in turn, relay instructions to other subsystems to execute the course of action.

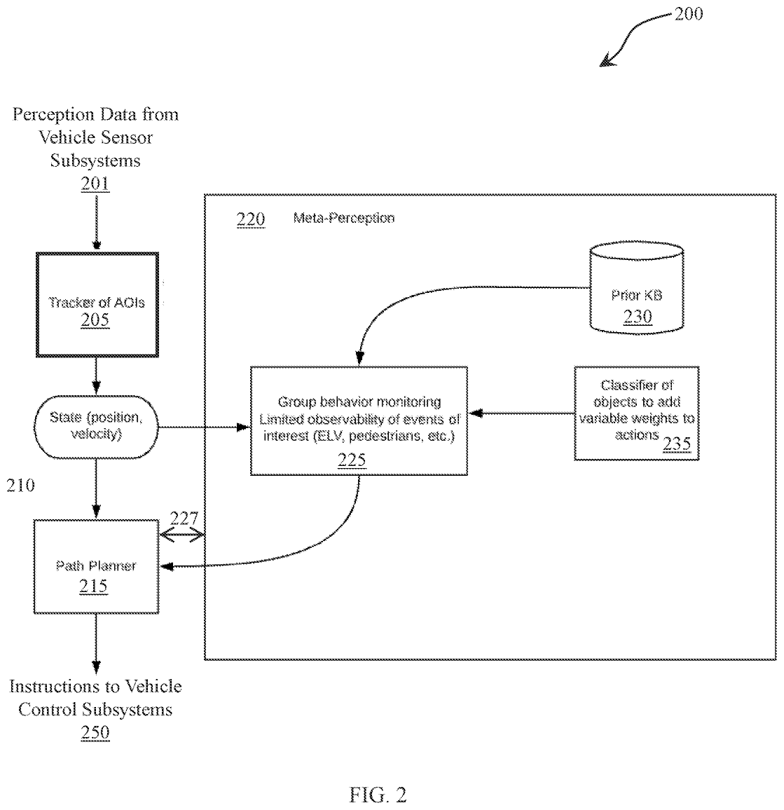

FIG. 2 shows a diagram of a system 200 according to some example embodiments. The system 200 can be located in (e.g., within or on) an autonomous vehicle and can include, for example, one or more data handling modules and/or one or more data sources. In some example embodiments, the data handling modules and/or data sources can be included in and/or can be a part of and/or can be in communication with an in-vehicle control computer (e.g., VCU 150) of the autonomous vehicle (e.g., the autonomous vehicle 105).

The system 200 can include a tracking module 205 which can be configured to track agents of interest (AOI), a path planning module 215, and/or a meta-perception module 220. In some example embodiments, the meta-perception module 220 can be, for example, the meta perception module 165 or can be a different module or a module which is similar (with respect to any parameter or characteristic) to the module 165. In some example embodiments, the system 200 can include a vehicle state module 210 which can be configured to monitor the state of the autonomous vehicle and can be further configured to accept information from the tracking module 205. The vehicle state module 210 can be configured to pass information to the meta-perception module 220 and the path planning module 215. The path planning module 215 can be configured to receive and/or combine information or data from the vehicle state module 210 and/or the meta-perception module 220. Once the path planning module 215 has combined the data from the vehicle state module 210 and/or the meta-perception module 220, the path planning module 215 can send instructions to vehicle control subsystems (e.g., the vehicle control subsystems 146 of the vehicle 105).

The tracking module 205 can be configured to identify agents of interest including, e.g., vehicles, pedestrians, or other objects in a proximity to the autonomous vehicle and can be configured to monitor movements of these agents of interest from one time instant or point to the next. In some example embodiments, the tracking module 205 can be configured to identify agents of interest using, e.g., data from one or more sensors of the autonomous vehicle (e.g., a video camera or a LiDAR sensor). As shown in FIG. 2, the tracking module 205 can use perception data 201 from sensors of the autonomous vehicle (e.g., the sensors of the vehicle sensor subsystems 144 of the autonomous vehicle 105) to identify agents of interest.

The tracking module 205 can be configured to identify the agents of interest in (or using) a first frame of data (also referred to as a first data frame). The first frame of data can be, e.g., a frame of data (e.g., a video frame) obtained by the tracking module 205 from one or more sensors of the autonomous vehicle at a first point in time. According to some example embodiments, the tracking module 205 can be configured to determine and/or record a location of each AOI identified in (or using) the first frame of data. The tracking module 205 can be also configured to identify agents of interest in (or using) a second, later frame of data. The second frame of data can be, e.g., a frame of data obtained by the tracking module 205 from the one or more sensors of the autonomous vehicle at a second point in time which is later than the first point in time. The tracking module 205 can be further configured to determine and/or record a location of each AOI identified in (or using) the second frame of data. In some example embodiments, the tracking module 205 can be configured to tag the AOIs that were identified in the first frame of data in the second frame of data. In some example embodiments, the tracking module 205 can be configured to determine a trajectory for each of one or more AOIs identified in the first frame of data based on the locations of the AOIs determined in (or using) the first frame of data and the locations of the AOIs determined in (or using) the second frame of data. According to some example embodiments, the tracking module 205 can be configured to create or build a record of one or more of the determined AOI trajectories. The same type of tracking as the one described above may be done using different types of sensor data, such as LiDAR data or radar data or video frame data taken or captured over time.

Agents of interest (AOIs) may include, e.g., vehicles in the same lane as the autonomous vehicle, as well as vehicles in lanes adjacent to that of the autonomous vehicle, vehicles parked in an emergency lane, pedestrians, emergency vehicles (e.g., tow trucks, law enforcement vehicles, ambulances, fire trucks), or construction vehicles. The tracking module 205 may categorize the AOIs each as falling into one of: a short perception range, a near perception range, a mid-perception range, or a far perception range distance categories. Tracking the AOIs may be expressed as one or more graphs.

The vehicle state module 210 can be configured to monitor the status of various systems and/or subsystems of the autonomous vehicle. The (sub)systems of the autonomous vehicle that are monitored may include the vehicle drive subsystems (142 in FIG. 1), the vehicle sensor subsystems (144 in FIG. 1), and the vehicle control subsystems (146 in FIG. 1). Aspects of the autonomous vehicle that may be monitored by the vehicle state module 210 may include the location of the vehicle, the velocity and acceleration of the vehicle, the intended trajectory or path of the vehicle, vehicle positioning (e.g., inclination on a hill or slope, pitch or yaw along a curved on/off ramp), positioning on a multi-lane highway, system health, fuel or maintenance needs, load parameters, etc.

The meta-perception module 220 may include one or more processors and a memory including processor-executable instructions which, when executed by the one or more processors, cause the meta-perception module to combine many/different types of information, data or knowledge in order to infer information related to, e.g., a situation or a scenario involving the autonomous vehicle and/or to assign a confidence level to a hazard detected by, e.g., the sensor subsystems of the autonomous vehicle, for example. Algorithms and/or computing modules that may be included in the meta-perception module 220 may include an object classifier 235 and/or a group behavior monitoring module 225. Information that may be a part of the meta-perception module 220 may include a prior knowledge base 230. The meta-perception module 220 may obtain perception information either directly from one or more sensors or sensor subsystems of the autonomous vehicle or via, e.g., the vehicle state module 210 or the path planning module 215.

The information contained in the prior knowledge base 230 can be stored, for example, on one or more data storage devices and/or non-transient computer-readable storage media. The information in the prior knowledge base 230 can be stored locally within or proximate to the autonomous vehicle (e.g., within the meta-perception module 220 of the autonomous vehicle) or can be stored remotely with respect to the autonomous vehicle on, e.g., a remote server (also referred to as a cloud server). The prior knowledge base 230 may be configured to provide information that it stores or includes to the group behavior monitoring module 225 in response to a request from the group behavior monitoring module 225 in some example embodiments. The information provided by the prior knowledge base 230 can give a context to the perception data that come into the meta-perception module 220 from, e.g., the vehicle state module 210 or, in some embodiments, directly from the sensors of the autonomous vehicle. The prior knowledge base 230 may include historic data for an area, such as a regional map or a database of average traffic density in a location as a function of a day of the week and/or a time of the day, and/or as a function of a proximity to a major holiday, for example. Information gathered from external sources, such as a command center, a transportation authority, a weather authority, or a traffic authority that, e.g., can alert drivers to accidents (e.g., CalTrans SIGalerts) and received via, e.g., wireless communication by the autonomous vehicle may also be part of the prior knowledge base 230.

The object classifier 235 may behave similarly to the tracking module 205 in that it can be configured to identify and track objects in the incoming data (e.g., perception information or data which are, e.g., captured by the sensors of the autonomous vehicle) over time. In some example embodiments, the object classifier 235 may receive information or data from the tracking module 205. According to some example embodiments, the object classifier 235 may include the tracking module 205. In some example embodiments, the tracking module 205 may include the object classifier 235.

In addition to agents of interest present, e.g., in front of the autonomous vehicle, the object classifier 235 may identify and/or track peripheral objects (and/or actions) of interest. The peripheral objects (or actions) of interest may include, e.g., emergency line vehicles or law enforcement vehicles (ELVs), vehicles on a side road adjacent to a highway, derbies or side shows, gatherings of vehicles and/or people that are not directly in the flow of traffic, vehicles stopped along a roadway, and/or other situations or scenarios that may influence traffic due to rubbernecking or looky-loos driver behavior.

In some example embodiments, the object classifier 235 may add another layer to the tracking of objects performed by the tracking module 205. Actions or states or behaviors of the identified objects, as they (objects and/or actions, states or behaviors) are tracked (by the object classifier 235 and/or the tracking module 205) in the incoming perception data, may be given various weight values. These weight values can be passed to the group behavior monitoring module 225, for example. The group behavior monitoring module 225 may be configured to consider actions, states, or behaviors of each identified object according to the weights assigned to them by the object classifier 235, as well as in light of the information from, e.g., the prior knowledge base 230 and/or other data (e.g., perception data).

Some example states and behaviors which can be associated with vehicles, including autonomous ones, are described above. A state associated with a pedestrian, for example, can include information related to whether the pedestrian is crossing a road on which the autonomous vehicle is driving, a position of the pedestrian (e.g., relative to the autonomous vehicle), and/or a velocity of the pedestrian (which can be used to determine pedestrian's behavior such as, e.g., if the pedestrian is standing still, walking or running) A state associated with a traffic light may include, for example, information related to a current color of the traffic light (e.g., green, yellow or red) and/or time elapsed since the traffic light changed its color. A state associated with a railroad crossing can include, e.g., information related to whether the gate of the crossing is open or closed.

In some example embodiments, information from the prior knowledge base 230 and/or the object classifier 235 provided to the group behavior monitoring module 225 may be combined with information provided to the group behavior monitoring module 225 by the vehicle state module 210. The group behavior monitoring module 225 can be configured to use the information from the prior knowledge base 230, the object classifier 235, and/or the vehicle state module 210 to confirm or reject the presence (or, alternatively, the absence) of a hazard determined based on the data provided by one or more of the vehicle sensors (e.g., sensors of one or more vehicle sensor subsystems such as, e.g., the vehicle sensor subsystems 144). The information may include, e.g., information about the position of the autonomous vehicle, the expected conditions based upon the vehicle's position (the conditions can be determined, e.g., using a map (e.g., a regional map) and/or information from a weather authority or source, or a traffic information authority or source that, e.g., can alert drivers to accidents), and/or information about the actions, states or behaviors of agents of interest, including the weight values assigned to the actions, states and/or behaviors of the agents of interest by the object classifier 235. The confirmation or rejection of the presence (or the absence) of a hazard may be expressed as a confidence level assigned, by, e.g., the meta-perception module 220, to the perception data indicating the presence (or the absence) of the hazard. For example, if the confidence level assigned to the perception data indicating the presence (or the absence) of a hazard is above a certain (e.g., predetermined) threshold value, then the presence (or the absence) of the hazard may be confirmed according to some example embodiments. If, on the other hand, the confidence level assigned to the perception data indicating the presence (or the absence) of a hazard is below a certain (e.g., predetermined) threshold value, then the presence (or the absence) of the hazard may be rejected according to some example embodiments. The initial confidence level for the perception data may be determined by, e.g., the path planning module 215 based, e.g., at least in part on the vehicle state (which may be provided to the path planning module 215 by the vehicle state module 210 in some example embodiments).

Perception data may refer to data or signals (e.g., digital and/or analog) produced or generated by a sensor (or multiple sensors) of an autonomous vehicle (also referred to as raw sensor data). Perception data may also refer to data produced or generated via processing or transforming the raw sensor data. For example, perception data may include an indication of a presence of an object proximate to the autonomous vehicle which can (potentially) interfere with a planned path or trajectory of the autonomous vehicle. Such an object can be referred to as a hazard. The perception data indicating the presence of the hazard may be generated using raw sensor data obtained or received by a data processing device (e.g., a processor which can be, for example, a part of the in-vehicle control computer) from the sensors of the autonomous vehicle. Perception data may also indicate, for example, an absence of objects that might interfere with the path of the autonomous vehicle.

The planning module 215 may determine an initial confidence level for raw sensor data generated by a sensor of the autonomous vehicle using, for example, a pre-defined dependence of the confidence level assigned to the raw sensor data on the data values of the raw sensor data. For example, sensor data which are close to a boundary of a perception range of the sensor (e.g., close to a maximum distance which can be measured using a LiDAR sensor) might be assigned a lower initial confidence level compared to the data corresponding to a middle of the sensor's perception range.

The planning module 215 may determine an initial confidence level for data or information obtained using raw sensor data based, for example, on a level or a value of classification probability assigned to the information or data. For example, an initial confidence level for indication of a presence of a potential hazard along the autonomous vehicle path may be determined based on, e.g., a probability of classifying an object identified using the raw sensor data as a hazard. The classification probability values can be determined and assigned to the information/data using or based on, e.g., a machine-learning model of the autonomous vehicle interactions with various driving environments.

The initial confidence level for the perception data may be sent by the path planning module 215 to the meta-perception module 220 via, e.g., a communication link 227 between the path planning module 215 and the meta-perception module 220. The path planning module 215 may be configured to determine and send a value of the initial confidence level to the meta-perception module 220 periodically in some example embodiments. According to some example embodiments, the path planning module 215 may be configured to send a message to the meta-perception module 220 (e.g., via the communication link 227) indicating that the path planning module 215 is ready (or will be ready) to send a value of an initial confidence level to the meta-perception module 220 and, further, send the initial confidence level value to the meta-perception module 220 in response to a reply message received from the meta-perception module 220.

The meta-perception module 220 may modify an initial confidence level assigned to perception data received, e.g., from the vehicle sensor subsystems or an initial confidence level assigned to an identification (e.g., of a potential hazard) or an estimate (e.g., that there are no potential hazards in a certain area proximate to the autonomous vehicle) made using the perception data. This modification may be performed based on, e.g., information from the group behavior monitoring module 225, prior knowledge base 230, object classifier 235, and/or the vehicle state module 210. For example, the prior knowledge base 230 may indicate that a location identified by the vehicle state module 210 provides poor visibility because of a blind corner or some other occluding condition, causing the meta-perception module 220 to lower initial confidence level of absence of hazard objects (e.g., other vehicles) around the blind intersection made, e.g., by the path planning module 215. A confidence level may also be assigned to regional map information or data provided by, e.g., the prior knowledge base 230. The group behavior monitoring module 225 may modify an initial confidence level of perception data and/or an initial confidence level of a regional map data by, e.g., utilizing the weight values assigned by the classifier 235 to the (observed) actions, states and/or behaviors of the identified objects. The output of the meta-perception module 220 may include modified confidence level values and may be passed (e.g., by the meta-perception module 220) to the planning module 215. The planning module 215 may be configured to generate instructions 250 that may cause the vehicle control subsystems to operate the autonomous vehicle in a way that accounts for the potential hazard.

Behaviors or actions that the group behavior monitoring module 225 and/or the object identifier 235 may identify and/or track may also include: changing lanes, reducing speed, flashing lights (e.g. hazard lights or emergency vehicle lights), swerving, oscillating speed, two or more cars coordinating movement (e.g. “playing tag”), vehicle convoys (e.g., funeral processions, parades), motorcycle groups, multiple vehicles aggregating or slowing ahead of an area that lacks traffic control signals or signage, etc. The meta-perception module 220, particularly the group behavior monitoring module 225, may differentiate or classify these behaviors into normal behavior patterns and abnormal behavior patterns. Normal behavior patterns may include those that are frequently encountered or are usual for a location or time of day. This frequency may be indicated by or determined using information from the prior knowledge base 230 or the perception or tracking data recently acquired by the autonomous vehicle. The abnormal behavior patterns may include those that are not frequently encountered or are rarely seen, as indicated by the prior knowledge base 230 or by the recently acquired perception and tracking data Binning or grouping behaviors in this way may optimize accuracy of modified confidence level values passed to the planning module 215, and in turn maximize the accuracy of predictions and planning instructions 250 passed by the planning module 215 to the vehicle control subsystems. The group behavior monitoring module 225, or the meta-perception module 220 in general, may be trained on these behavior patterns or on scenarios containing these behaviors to improve the confidence level adjustments made and passed to the planning module 215.

Example scenarios or sates of the autonomous vehicle when the meta-perception module 220 may be used to modify the value of a confidence level of perception data or the value of a confidence level of regional map data in order to confirm or reject an identification of a hazard done based on the perception data and/or the regional map data in a more accurate manner include the following: the vehicle being in a hilly area or at or near a blind intersection, limited visibility due to weather or lighting conditions, limited visibility due to limitations of the autonomous vehicle sensors, limited observability of vehicles in an emergency lane, an interruption in tracking of AOIs, a short duration of AOI tracking, debris on the road, faded or missing lane markings, occluded signal lights or traffic signs, objects or AOIs coming in and out of perception range of the autonomous vehicle sensors, and the like. In some instances, when an object of interest is transient, e.g., it comes in and out of the perception range of a sensor of the autonomous vehicle, it may be considered a real potential hazard or object to be tracked when the object persists for at least 5 seconds in the perception range of one or more sensors of the autonomous vehicle. In such scenarios or sates, the meta-perception module 220 of the autonomous vehicle can use information provided, for example, by the group behavior monitoring module 225 and/or the prior knowledge base 230 to adjust an initial estimate of the confidence level of a hazard presence (or a hazard absence) identification made based, e.g., on the data captured by the autonomous vehicle sensors. For example, if the initial confidence level ascribed to a potential hazard by, e.g., the path planning module 215 of the autonomous vehicle based on the perception data is relatively low but the group behavior monitoring module 225 indicates, based on the perception data, that a collective trajectory of the vehicles in a proximity to the autonomous vehicle is such that it avoids or goes around the location of the identified potential hazard, then the meta-perception module 220 can adjust the initial confidence level value. For example, in such a case, the meta-perception module 220 may increase the confidence level assigned to the presence of the potential hazard. Similarly, when the meta-perception module 220 of the autonomous vehicle may determine, using, e.g., data from the knowledge base 230, that the autonomous vehicle is moving in a hilly area or at or near a blind intersection, or in situations when visibility is limited due to weather or lighting conditions or due to limitations of the autonomous vehicle sensors, the meta-perception module 220 may adjust the initial estimate of a potential hazard absence (done, e.g., by the path planning module 215) or may generate a new potential hazard indication. For example, when the autonomous vehicle is approaching a blind intersection, the meta-perception module 220 can decrease the level of confidence that the area around the blind intersection is free from potential hazards.

The planning module 215 may utilize combinatorial methods, learning methods, or probabilistic methods to process the perception data, tracking data, and confidence values to create instructions 250 passed to the vehicle control subsystems of the autonomous vehicle.

According to some example embodiments, any of the tracking module 205, vehicle state module 210, path planning module 215, meta-perception module 220, group behavior monitoring module 225, prior knowledge base 230, or object classifier 235 may be implemented by or using an in-vehicle computer of the autonomous vehicle (e.g., the in-vehicle control computer 150 of the autonomous vehicle 105). In some example embodiments, any of the tracking module 205, vehicle state module 210, path planning module 215, meta-perception module 220, group behavior monitoring module 225, prior knowledge base (or module) 230, or object classifier 235 modules or bases may be implemented in or using a device which may include one or more processors and a memory storing processor-executable (also referred to as computer-executable) instructions which, when executed by the one or more processors cause the mentioned modules to perform one or more actions linked to the module in the present disclosure.

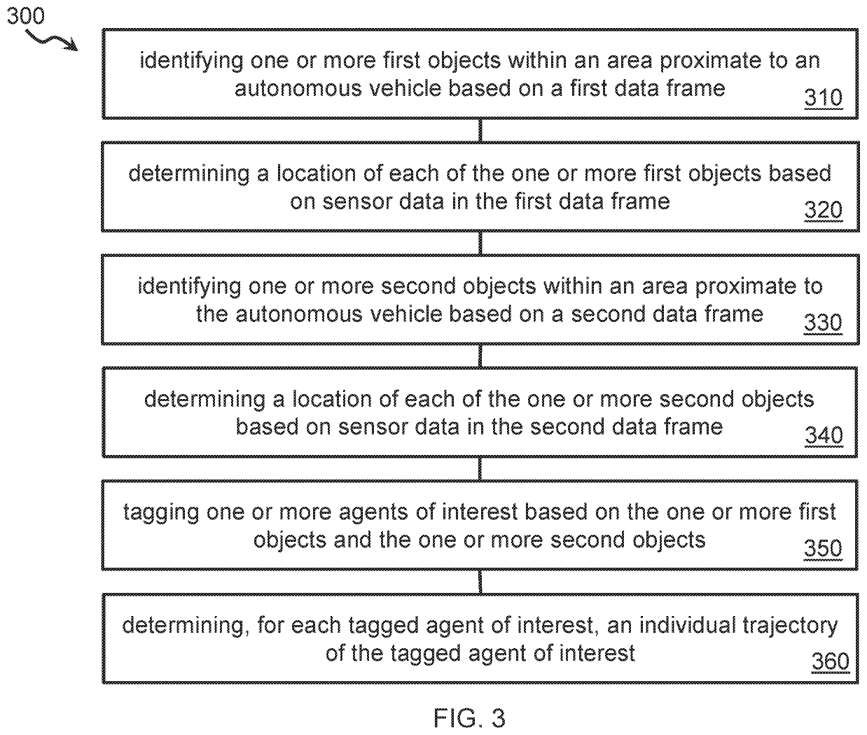

FIG. 3 shows a flow diagram of a method 300 according to some example embodiments. At 310, the VCU may, based on a first data frame, identify one or more first objects within an area proximate to an autonomous vehicle. The first data frame may include data obtained from one or more sensors of the autonomous vehicle, which may include, for example, video cameras, still cameras, LiDAR, radar, and/or the like. The VCU may obtain the first data frame at a first point in time. The VCU may identify each of the one or more first objects based on an output of a first trained classifier. To identify the one or more first objects, the VCU may provide, to the first trained classifier, the first data frame and/or one or more subframes of the first data frame.

The VCU may determine, based on the first data frame, an object classification for each of the one or more first objects in the first data frame. The object classifications may include vehicles, pedestrians, emergency vehicles, roadside infrastructure, and/or the like. For example, the VCU may determine that the first data frame includes one or more vehicles, one or more pedestrians, one or more emergency vehicles, one or more signposts, and/or the like. The VCU may determine, based on the first data frame, object features associated with each of the one or more first objects. The object features may include a vehicle make and/or model, a license plate number, an outline of the object, an estimated size of the object, a color associated with some portions of the object, physical characteristics of the object, and/or the like. The VCU may determine the object features based on an output of a second trained classifier. To obtain the object features from the second trained classifier, the VCU may provide, as inputs, the first data frame and/or subframes of the first data frame to the second trained classifier.

At 320, the VCU may determine, based on sensor data in the first data frame, a location of each of the one or more first objects. The VCU may store an object identifier, the object classification, the object features, and/or the object location for each of the one or more first objects. The location of each of the one or more first objects may be relative to a regional map, a vehicle coordinate system, and/or the like. The VCU may determine the location of each of the one or more first objects based on a global positioning system location of the autonomous vehicle, data received from the one or more sensors, a calibration of the one or more sensors, and/or the like.

At 330, the VCU may, based on a second data frame, identify one or more second objects within an area proximate to the autonomous vehicle. The second data frame may include data obtained from the one or more sensors of the autonomous vehicle. The VCU may obtain the second data frame at a second point in time, which may be earlier than or later than the first point in time. The VCU may identify the one or more second objects in the second data frame based on an output of the first trained classifier. To identify the one or more second objects, the VCU may provide, to the first trained classifier, the second data frame and/or one or more subframes of the second data frame.

The VCU may determine, based on the second data frame, an object classification for each of the one or more second objects in the second data frame. The VCU may determine, based on the second data frame, object features associated with each of the one or more second objects. The VCU may determine the object features based on an output of a second trained classifier. To obtain the object features from the second trained classifier, the VCU may provide, as inputs, the second data frame and/or subframes of the second data frame to the second trained classifier.

At 340, the VCU may determine, based on sensor data in the second data frame, a location of each of the one or more second objects. The VCU may store an object identifier, the object classification, the object features, and/or the object location of each of the one or more second objects. The location of each of the one or more second objects may be relative to a regional map, a vehicle coordinate system, and/or the like. The VCU may determine the location of each of the one or more second objects based on a global positioning system location of the autonomous vehicle, data received from the one or more sensors, a calibration of the one or more sensors, and/or the like.

At 350, the VCU may, based on the one or more first objects and the one or more second objects, tag (e.g., label or select) one or more agents of interest. To tag an agent of interest, the VCU may compare the one or more first objects and the one or more second objects. The VCU may compare the object classification of a first object in the first data frame to the object classification of a second object in the second data frame. The VCU may compare the object features of the first object and the second object. The VCU may compare the location of the first object and the second object. Based on these comparisons, the VCU may determine whether the first object in the first data frame is the same as the second object in the second data frame. If VCU determines that the objects are the same, the VCU may identify the object as one of the agents of interest. For example, if the VCU detects a red vehicle in the first data frame and a red vehicle in the second data frame, the VCU may determine that the two vehicles are the same and identify the red vehicle as an agent of interest.

At 360, the VCU may determine, for each tagged (e.g., labeled or selected) agent of interest, an individual trajectory of the tagged agent of interest. The VCU may determine the individual trajectory based on a first location of the corresponding object obtained from the first data frame and a second location of the corresponding object obtained from the second data frame. Alternatively and/or additionally, the VCU may determine the individual trajectory of the tagged agent of interest based on the first time point associated with the first data frame and the second time point associated with the second data frame.

The VCU may create and/or build a record of one or more individual trajectories corresponding to each of the one or more tagged agents of interest. The VCU may determine, based on the one or more individual trajectories, a collective trajectory for the group of tagged agents of interest. The VCU may determine the collective trajectory based on a calculation, such as an arithmetic mean of the one or more individual trajectories, a vector summation of the one or more individual trajectories, or an output of one or more trained classifiers. To obtain the output of the trained classifier, the VCU may provide, as inputs to one or more of the trained classifiers, the one or more individual trajectories. Each of the trained classifiers may include a binary classifier, a multiclass classifier, naïve Bayes classifier, a support vector machine, a hierarchical classifier, and/or the like.

The VCU may, based on behavior and/or trajectory information, predict an action of an agent of interest. The behavior and/or trajectory information may include previous behaviors of the agent of interest, the location of the agent of interest relative to other agents of interest, the trajectory of the agent of interest, the trajectory of other agents of interest, the behavior of the other agents of interest, and/or the like. For example, if a first agent of interest is on a trajectory that will lead to a stalled vehicle, the VCU may predict that the first agent of interest will either slowdown in the lane or change lanes to avoid the stalled vehicle. If the lane next to the first agent of interest is clear, the first agent of interest may be more likely to change lanes than to slow down. On the other hand, if another agent of interest is in the next lane and next to or rapidly approaching the first agent of interest, the first agent of interest may be more likely to slow down than change lanes.

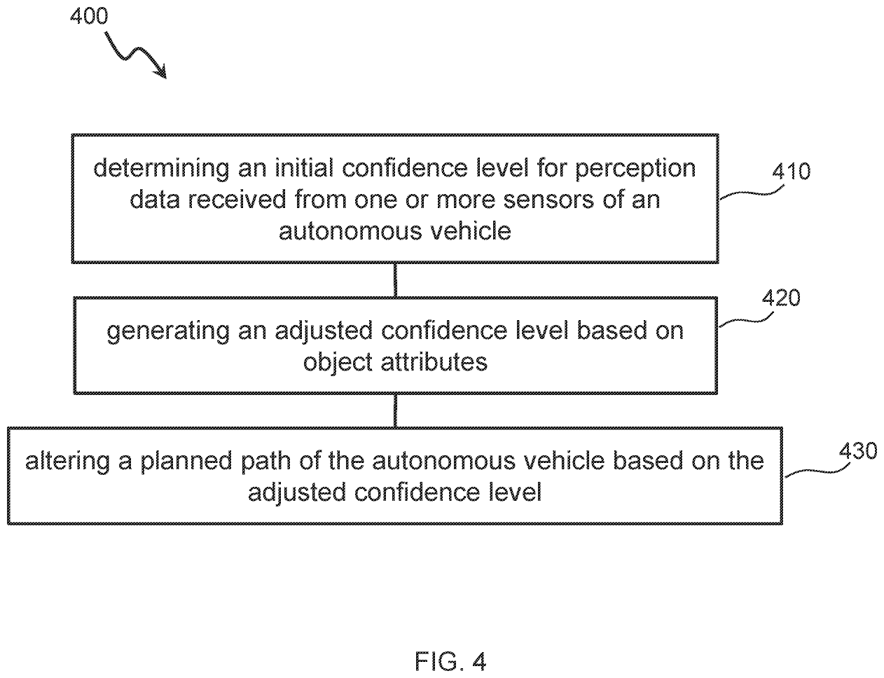

FIG. 4 shows a flow diagram of a method 400 according to some example embodiments. At 410, the VCU may determine an initial confidence level for perception data received from one or more sensors of the autonomous vehicle. As described above with respect to FIG. 1, the initial confidence level may include a confidence level for perception data of a regional map. The initial confidence level may be expressed as a percentage (e.g., a value between 0% and 100%) or as a fraction or a probability (e.g., a value between 0 and 1). The VCU may determine the initial confidence level based on a measure or quality of the perception data and/or the regional map.

At 420, the VCU may generate, based on object attributes, an adjusted confidence level (e.g., a modified the initial confidence level). The VCU may modify the initial confidence level to produce an adjusted confidence level. The object attributes may include, e.g., an action, a state, and/or a behavior of one or more objects in an area proximate to the autonomous vehicle. The VCU may determine the object attributes based on the perception data.

At 430, the VCU may, based on the adjusted confidence level, alter a planned path of the autonomous vehicle. To determine whether to alter the planned path of the autonomous vehicle, the VCU may determine, based on the perception data and the object attributes, a predicted presence or a predicted absence of a hazard along the planned path of the autonomous vehicle.

To predict the presence of a hazard along the planned path of the autonomous vehicle, the VCU may determine, based on the object attributes and a collective trajectory of the proximate objects, a collective or group behavior. If the collective behavior indicates the other objects may be avoiding a hazard, the VCU may alter the planned path of the autonomous vehicle to correspond to the collective trajectory of the proximate objects. The VCU may alter the planned path of the autonomous vehicle independent of whether the VCU perceives a hazard along the planned path of the autonomous vehicle.

For example, if the VCU perceives that one or more vehicles in front of the autonomous vehicle are biasing toward the left side of the lane, the VCU may predict, based on the collective behavior of the other vehicles, that a hazard is partially blocking the right side of the lane. The VCU may adjust the planned path of the autonomous vehicle to follow the collective trajectory of the other vehicles, e.g., by biasing toward the left side of the lane.

Alternatively, and/or additionally, the VCU may, based on the collective trajectory, individual trajectories, and/or collective behavior of proximate objects, predict the absence of a hazard. The VCU may first predict, based on data received from the sensors on the autonomous vehicle, the presence of a hazard in a particular location. The VCU may assign a first confidence level to the first prediction that the hazard exists. The VCU may also, based on e.g., the collective behavior of proximate objects, individual trajectories of proximate objects, and/or the collective trajectory of proximate objects, predict that the hazard is not present. The VCU may assign a second confidence level to the second prediction that the hazard is not present. If the first confidence level is greater than the second confidence level, the VCU may determine that the hazard exists and may adjust the planned path of the autonomous vehicle to avoid the hazard. On the other hand, if the second confidence level is greater than the first confidence level, the VCU may determine that the hazard does not exist. In response to determining that the hazard does not exist, the VCU may adjust the planned path of the autonomous vehicle to follow the collective trajectory of the proximate objects.

For example, if the VCU detects, based on a video feed, that an object is in the lane ahead of the autonomous vehicle, the VCU may assign a first confidence level that a hazard exists at that location. If the VCU perceives that one or more other vehicles ahead of the autonomous vehicle do not change their trajectory to avoid the perceived hazard and instead, continue to drive over the location of the perceived hazard, the VCU may assign a second confidence level to a prediction that the hazard does not exist. If multiple vehicles continue straight over the perceived hazard, the VCU may increase the second confidence level accordingly. If the second confidence level exceeds the first confidence level by more than a threshold confidence level, the VCU may determine that the perceived hazard does not need to be avoided, and may cause the autonomous vehicle to follow the planned path without adjusting the planned path.

An aspect of the disclosed embodiments relates to a method of determining a trajectory for an autonomous vehicle, comprising: determining, using a processor in the autonomous vehicle, an initial confidence level related to data generated by one or more sensors of the autonomous vehicle; determining an adjusted confidence level related to the data using the initial confidence level and one of: an action, a state, or a behavior of one or more objects in an area proximate to the autonomous vehicle; and altering a path of the autonomous vehicle using the adjusted confidence level.

In some example embodiments, the method includes determining the action or the state or the behavior of the one or more objects using the data. According to some example embodiments, the method includes determining a presence or an absence of a hazard in the area proximate to the autonomous vehicle using the data. In certain example embodiments, the adjusted confidence level is a confidence level of the presence of the hazard in the area proximate to the autonomous vehicle. In some example embodiments, the adjusted confidence level is a confidence level of the absence of the hazard in the area proximate to the autonomous vehicle. According to some example embodiments, the method includes determining a collective behavior of the one or more objects in the area proximate to the autonomous vehicle. In some example embodiments, the collective behavior of the one or more objects includes multiple vehicles aggregating or slowing ahead of an area that lacks traffic control signals or traffic signs. In certain example embodiments, the method includes causing the autonomous vehicle to follow along a collective trajectory of the one or more objects. According to some example embodiments, the obtaining the adjusted confidence level comprises using data from a prior knowledge base. In some example embodiments, the data from the prior knowledge base include a regional map, a database of average traffic density in a location as a function of a day of a week and/or a time of the day and/or a proximity to a major holiday, weather conditions, or traffic conditions.

Another aspect of the disclosed embodiments relates to a system, comprising: an autonomous vehicle, comprising: one or more sensors; an in-vehicle control computer, comprising: a meta-perception module configured to modify an initial confidence level related to data received by the in-vehicle control computer from the one or more sensors to generate an adjusted confidence level; and an autonomous driving control subsystem configured to alter a path of the autonomous vehicle using the adjusted confidence level.

In some example embodiments of the system, the in-vehicle control computer is configured to determine the initial confidence level using the data received by the in-vehicle control computer from the one or more sensors. According to some example embodiments, the meta-perception module comprises: an object classifier configured to identify and track one or more objects in an area proximate to the autonomous vehicle using the data; a group behavior monitor configured to determine a collective behavior of the one or more objects in the area proximate to the autonomous vehicle using data produced by the object classifier; and a prior knowledge base configured store information including: a regional map, a database of average traffic density in a location as a function of a day of a week and/or a time of the day, and/or a proximity to a major holiday, weather conditions, or traffic conditions. In certain example embodiments, the prior knowledge base is configured to provide the information to the group behavior monitor upon a request from the group behavior monitor. According to some example embodiments, the object classifier is configured to assign weights to actions of the one or more objects in the area proximate to the autonomous vehicle. In some example embodiments, the object classifier is configured to provide the weights assigned to the actions of the one or more objects in the area proximate to the autonomous vehicle to the group behavior monitor upon a request from the group behavior monitor. According to some example embodiments, the group behavior monitor is configured to modify the initial confidence level using information provided to the group behavior monitor by the object classifier and/or the prior knowledge base and/or a path planner of the autonomous vehicle. In certain example embodiments, the path planner of the autonomous vehicle is configured to generate the initial confidence level. In some example embodiments, the initial confidence level is a confidence level of a presence or an absence of a hazard proximate to the autonomous vehicle. According to some example embodiments, the actions of the one or more objects in the area proximate to the autonomous vehicle are determined using the data received by the in-vehicle control computer from the one or more sensors.

An aspect of the disclosed embodiments relates to a method, comprising: determining, based on sensor data received from one or more sensors of an autonomous vehicle, an initial confidence level based on an expected quality of the sensor data; determining, based on object attributes of one or more objects in an area proximate to the autonomous vehicle, an adjusted confidence level, each object attribute comprising a state, an action, and/or a behavior of each of the one or more objects in the area proximate to the autonomous vehicle; and altering, based on the adjusted confidence level, a planned path of the autonomous vehicle.

In some example embodiments, determining the initial confidence level comprises determining, based on data from a knowledge database, whether an expected visibility of the one or more sensors of the autonomous vehicle will be reduced and/or occluded at a location along the planned path of the autonomous vehicle. According to some example embodiments, the method further comprises determining, based on the received sensor data, a location and a trajectory of each of the one or more objects in the area proximate to the autonomous vehicle. In another example embodiment, the method also comprises: determining, based on the determined location and trajectory of each of the one or more objects in the area proximate to the autonomous vehicle, a collective trajectory of the one or more objects in the area proximate to the autonomous vehicle, and wherein altering the planned path of the autonomous vehicle comprises causing the autonomous vehicle to follow the collective trajectory of the one or more objects in the area proximate to the autonomous vehicle. In some example embodiments, the method further comprises determining, based on the object attributes of each of the one or more objects in the area proximate to the autonomous vehicle, an expected action of each of the one or more objects in the area proximate to the autonomous vehicle. According to certain example embodiments, the method further comprises determining, based on the received sensor data, a presence of a hazard and/or an absence of a hazard in the area proximate to the autonomous vehicle. In an example embodiment, altering the planned path of the autonomous vehicle comprises modifying the planned path to allow the autonomous vehicle to avoid the hazard in the area proximate to the autonomous vehicle. In some example embodiments, the method also comprises determining, based on the object attributes of the one or more objects in the area proximate to the autonomous vehicle, a collective behavior of the one or more objects in the area proximate to the autonomous vehicle. According to some example embodiments, the collective behavior of the one or more objects comprises at least one of multiple vehicles aggregating in an area and multiple vehicles slowing ahead of an area that lacks traffic control signals or traffic signs. In some example embodiments, the adjusted confidence level is determined based on data from a knowledge database including at least one of: a regional map, a database of average traffic density in a location as a function of a day of a week and/or a time of the day, a proximity to a major holiday, weather conditions, or traffic conditions.

Another aspect of the disclosed embodiments relates to an apparatus comprising: one or more processors; and at least one memory including computer program instructions which, when executed by the one or more processors, cause operations comprising: determining, based on sensor data received from one or more sensors of an autonomous vehicle, an initial confidence level based on an expected quality of the sensor data; determining, based on object attributes of one or more objects in an area proximate to the autonomous vehicle, an adjusted confidence level, each object attribute comprising a state, an action, and/or a behavior of each of the one or more objects in the area proximate to the autonomous vehicle; and altering, based on the adjusted confidence level, a planned path of the autonomous vehicle.

In an example embodiment, the operations further comprise: calculating, based on the received sensor data, a location and a trajectory for each of the one or more objects in the area proximate to the autonomous vehicle. In another example embodiment, the operations further comprise: determining, based on the location and trajectory of each of the one or more objects in the area proximate to the autonomous vehicle, a collective trajectory of the one or more objects in the area proximate to the autonomous vehicle. In some example embodiments, the operations further comprise: storing, in a knowledge database, at least one of: a regional map, an average traffic density for a location and as a function of a day of a week and/or a time of the day, a proximity to a major holiday, weather conditions, or traffic conditions; and determining, based on the data stored in the knowledge database and the object attributes of the one or more objects in the area proximate to the autonomous vehicle, a group behavior for the one or more objects proximate to the autonomous vehicle. According to some example embodiments, the operations further comprise: determining, based on an output of a trained classifier, the group behavior. In an example embodiment, the operations further comprise: monitoring the group behavior monitor, and wherein the initial confidence level is modified based on at least one of the group behavior, the data stored in the knowledge database, or the planned path of the autonomous vehicle. In an example embodiment, the operations further comprise generating, based on the received sensor data, a regional map, and wherein the initial confidence level comprises a confidence level of the regional map. In some example embodiments, each object attribute of the one or more objects proximate to the autonomous vehicle comprises an action, and wherein the operations further comprise: assigning, based on an output of an object classifier, a weight to the actions of the one or more objects in the area proximate to the autonomous vehicle. According to some example embodiments, the actions of the one or more objects in the area proximate to the autonomous vehicle are determined based on the received sensor data.

Yet another aspect of the disclosed embodiments relates to a non-transitory computer readable medium including instructions which, when executed by at least one processor, cause operations comprising: determining, based on sensor data received from one or more sensors of an autonomous vehicle, an initial confidence level based on an expected quality of the sensor data; determining, based on object attributes of one or more objects in an area proximate to the autonomous vehicle, an adjusted confidence level, each object attribute comprising a state, an action, and/or a behavior of each of the one or more objects in the area proximate to the autonomous vehicle; and altering, based on the adjusted confidence level, a planned path of the autonomous vehicle.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

Implementations of the subject matter and the functional operations described in this patent document can be implemented in various systems, semiconductor devices, ultrasonic devices, digital electronic circuitry, or in computer software, firmware, or hardware, including the structures disclosed in this specification and their structural equivalents, or in combinations of one or more of them. Implementations of aspects of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

In this disclosure, LiDAR or LIDAR are used to refer to light detection and ranging devices and methods, and alternatively, or additionally, laser detection and ranging devices and methods. The use of these acronyms does not imply limitation of the described devices, systems, or methods to the use of one over the other.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method, comprising:
determining, based on sensor data received from one or more sensors of an autonomous vehicle, an initial confidence level based on an expected quality of the sensor data;
determining, based on object attributes of one or more objects in an area proximate to the autonomous vehicle, an adjusted confidence level, each object attribute comprising a state, an action, and/or a behavior of each of the one or more objects in the area proximate to the autonomous vehicle; and
altering, based on the adjusted confidence level, a planned path of the autonomous vehicle.

2. The method of claim 1, wherein determining the initial confidence level comprises determining, based on data from a knowledge database, whether an expected visibility of the one or more sensors of the autonomous vehicle will be reduced and/or occluded at a location along the planned path of the autonomous vehicle.

3. The method of claim 1, further comprising:
determining, based on the received sensor data, a location and a trajectory of each of the one or more objects in the area proximate to the autonomous vehicle.

4. The method of claim 3, further comprising:
determining, based on the determined location and trajectory of each of the one or more objects in the area proximate to the autonomous vehicle, a collective trajectory of the one or more objects in the area proximate to the autonomous vehicle, and
wherein altering the planned path of the autonomous vehicle comprises causing the autonomous vehicle to follow the collective trajectory of the one or more objects in the area proximate to the autonomous vehicle.

5. The method of claim 3, further comprising determining, based on the object attributes of each of the one or more objects in the area proximate to the autonomous vehicle, an expected action of each of the one or more objects in the area proximate to the autonomous vehicle.

6. The method of claim 1, further comprising:
determining, based on the received sensor data, a presence of a hazard and/or an absence of a hazard in the area proximate to the autonomous vehicle.

7. The method of claim 6, wherein altering the planned path of the autonomous vehicle comprises modifying the planned path to allow the autonomous vehicle to avoid the hazard in the area proximate to the autonomous vehicle.

8. The method of claim 1, further comprising:
determining, based on the object attributes of the one or more objects in the area proximate to the autonomous vehicle, a collective behavior of the one or more objects in the area proximate to the autonomous vehicle.

9. The method of claim 8, wherein the collective behavior of the one or more objects comprises at least one of multiple vehicles aggregating in an area and multiple vehicles slowing ahead of an area that lacks traffic control signals or traffic signs.

10. The method of claim 1,
wherein the adjusted confidence level is determined based on data from a knowledge database including at least one of a regional map, a database of average traffic density in a location as a function of: a day of a week and/or a time of the day, a proximity to a major holiday, weather conditions, or traffic conditions.

11. An apparatus comprising:
one or more processors; and
at least one memory including computer program instructions which, when executed by the one or more processors, cause operations comprising:
determining, based on sensor data received from one or more sensors of an autonomous vehicle, an initial confidence level based on an expected quality of the sensor data;
determining, based on object attributes of one or more objects in an area proximate to the autonomous vehicle, an adjusted confidence level, each object attribute comprising a state, an action, and/or a behavior of each of the one or more objects in the area proximate to the autonomous vehicle; and
altering, based on the adjusted confidence level, a planned path of the autonomous vehicle.

12. The apparatus of claim 11, wherein the operations further comprise:
calculating, based on the received sensor data, a location and a trajectory for each of the one or more objects in the area proximate to the autonomous vehicle.

13. The apparatus of claim 12, wherein the operations further comprise:
determining, based on the location and trajectory of each of the one or more objects in the area proximate to the autonomous vehicle, a collective trajectory of the one or more objects in the area proximate to the autonomous vehicle.

14. The apparatus of claim 11, wherein the operations further comprise:
storing, in a knowledge database, at least one of: a regional map, an average traffic density for a location and as a function of a day of a week and/or a time of the day, a proximity to a major holiday, weather conditions, or traffic conditions; and
determining, based on the data stored in the knowledge database and the object attributes of the one or more objects in the area proximate to the autonomous vehicle, a group behavior for the one or more objects proximate to the autonomous vehicle.

15. The apparatus of claim 14, wherein the operations further comprise:
determining, based on an output of a trained classifier, the group behavior.

16. The apparatus of claim 15, wherein the operations further comprise:
monitoring the group behavior monitor, and
wherein the initial confidence level is modified based on at least one of the group behavior, the data stored in the knowledge database, or the planned path of the autonomous vehicle.

17. The apparatus of claim 11, wherein the operations further comprise generating, based on the received sensor data, a regional map, and wherein the initial confidence level comprises a confidence level of the regional map.

18. The apparatus of claim 11, wherein each object attribute of the one or more objects proximate to the autonomous vehicle comprises an action, and
wherein the operations further comprise:
assigning, based on an output of an object classifier, a weight to the actions of the one or more objects in the area proximate to the autonomous vehicle.

19. The apparatus of claim 18, wherein the actions of the one or more objects in the area proximate to the autonomous vehicle are determined based on the received sensor data.

20. A non-transitory computer readable medium including instructions which, when executed by at least one processor, cause operations comprising:
determining, based on sensor data received from one or more sensors of an autonomous vehicle, an initial confidence level based on an expected quality of the sensor data;
determining, based on object attributes of one or more objects in an area proximate to the autonomous vehicle, an adjusted confidence level, each object attribute comprising a state, an action, and/or a behavior of each of the one or more objects in the area proximate to the autonomous vehicle; and
altering, based on the adjusted confidence level, a planned path of the autonomous vehicle.
